(19) United States
(12) Patent Application Publication
(10) Pub. No.: US 2026/0299370 A1
(43) Pub. Date: Oct. 1, 2026

(54) SEMICONDUCTOR OPTICAL MODULATOR

(71) Applicants: NTT, Inc., Tokyo (JP); NTT Innovative Devices Corporation, Kanagawa (JP)

(72) Inventors: Yoshihiro Ogiso, Tokyo (JP); Josuke Ozaki, Tokyo (JP); Yasuaki Hashizume, Tokyo (JP); Nobuhiro Nunoya, Tokyo (JP); Yotaro Shimpo, Kanagawa (JP)

(21) Appl. No.: 19/490,241

(22) PCT Filed: May 28, 2024
(86) PCT No.: PCT/JP2024/019585

§ 371 Date: Dec. 4, 2025

(30) Foreign Application Priority Data
Jun. 5, 2023 (JP) 2023-092324

(51) Int. Cl. G02F 1/225; G02F 1/21

(52) U.S. Cl. CPC G02F 1/2257; G02F 1/212; G02F 2201/063; G02F 2202/06; G02F 2202/108

(57) ABSTRACT

A Mach-Zehnder semiconductor optical modulator is provided herein. The Mach-Zehnder semiconductor optical modulator comprises an input optical waveguide, two interference optical waveguides branched from the input optical waveguide in which a refractive index of a core is modulated by an electrical signal, and an output optical waveguide for multiplexed modulated light from the two interference optical waveguides. In each of the interference optical waveguides, a first n-type clad layer, a p-type electron barrier layer, a first buffer layer, a multi quantum well layer constituting the core, a second buffer layer, and a second n-type clad layer are arranged on a substrate surface equivalent to a (100) plane of a semi-insulating InP semiconductor crystal substrate in an order named from the InP semiconductor crystal substrate to an upper layer. The first buffer layer contains only As as a V group element.

### CROSS-REFERENCE TO RELATED APPLICATIONS

This application is a national phase entry of PCT Application No. PCT/JP2024/019585, filed on May 28, 2024, which claims priority to Japanese Patent Application No. 2023-092324, filed on Jun. 5, 2023, which applications are hereby incorporated herein by reference.

### TECHNICAL FIELD

The present invention relates to an optical modulator and, more particularly, to an n-i-p-n-type optical modulator.

### BACKGROUND

As the IoT and 5G (5th generation mobile communication system) services become widespread, optical communication networks supporting these are required to be more speeded up. Concerning an optical modulator that is one of key devices, R&D has been continuously conducted to implement higher performance and size reduction/lower power consumption. A Mach-Zehnder Modulator (MZM) using a compound semiconductor such as InP has received great deal of attention particularly in terms of high speed.

There are various approaches done to speed up the optical modulator made of a semiconductor, and an n-p-i-n structure or n-i-p-n structure has been proposed from the viewpoint of a semiconductor layer (patent literature 1). In these structures, focus is placed on the fact that a factor to limit the increase of the speed of the semiconductor optical modulator is in the low resistance characteristic of a semiconductor doping layer. In place of a p-type doping layer having a resistivity approximately one order of magnitude higher at the same concentration, n-type doping layers arranged on the upper and lower sides of a layer structure, thereby implementing both a broadband characteristic and a low driving voltage characteristic (non-patent literature 1).

FIGS. 1A and 1B show the layer structure and the band diagram of a semiconductor optical modulator according to a related art. FIG. 1A shows a layer structure 100 of a cross section of an optical waveguide that performs a modulation operation of an MZM. Focusing on the configuration of a semiconductor layer with an n-i-p-n structure, a part thereof is cut out and schematically shown. FIG. 1B shows a band diagram corresponding to the n-i-p-n structure shown in FIG. 1A. In the following explanation, an optical modulator and an optical modulation element mean the same device.

As shown in FIG. 1A, an n-type clad layer 12, a p-type diffusion stop layer 18, an undoped layer (i-type layer) including a plurality of layers including the core layer of an optical waveguide, and an n-type clad layer 17 are stacked sequentially from the lower side where an InP substrate (not shown) is present. The undoped layer includes a first buffer layer 14, an MQW layer 15 that has a multi quantum well (MQW) structure and functions as a core layer, and a second buffer layer 16 sequentially from the substrate side. An n-type layer, an i-type layer, a p-type layer, and an n-type layer are formed sequentially from the upper layer side to the substrate side, and this is called an n-i-p-n structure. Only the MQW layer 15 in the i-type layer functions as an optical waveguide core. The undoped i-type layer including the plurality of layers decides an electrical electrostatic capacitance (capacitor), as will be described later.

If the most part of the clad of the optical waveguide of the MZM is formed by the first n-type clad layer 12 and the second n-type clad layer 17, which are n-type doping layers, like the above-described n-i-p-n structure, a p-type doping layer is needed to secure the breakdown voltage when applying a reverse bias voltage. In FIG. 1A, the p-type doping layer is shown as an electron barrier layer 13. In the semiconductor device formed on the InP substrate, Zn, Be, C, or the like is used as a dopant used for the electron barrier layer 13. When growing a crystal by the MOVPE method that is used to produce a compound semiconductor crystal and is also suitable for mass production, Zn is used as a dopant in most cases.

The Zn dopant is known to have a very large diffusion coefficient, and when designing an optical device such as a laser diode or an optical modulator, how to suppress Zn diffusion is an important problem. In general, an effective method for suppressing Zn diffusion is to form a heterointerface of a different bandgap between a layer doped with Zn and an undoped core layer. For example, it is known that, to prevent Zn diffusion from a p-InP clad layer, an undoped InGaAsP layer, InAlGaAs layer, or InAlAs layer whose saturated concentration is higher than InP is inserted adjacent to the clad layer. Particularly, InGaAsP exhibits the highest saturated concentration characteristic and is therefore expected to have a high Zn diffusion preventing effect.

In the layer configuration of the semiconductor optical modulation element of the n-i-p-n structure shown in FIG. 1A, the diffusion stop layer 18 made of InGaAsP is provided as the above-described layer for preventing Zn diffusion between the first n-type clad layer 12 and the first buffer layer 14. The InGaAsP layer contains both As and P as V group elements and is therefore often used as an intermediate layer to switch from an InAlAs layer to an InP layer. When the intermediate layer is formed between layers, crystal defects can be decreased.

The band diagram of FIG. 1B corresponds to the layer configuration of the above-described semiconductor optical modulation element with the n-i-p-n structure. The electron barrier layer 13 is shown like a dam wall having such a doping concentration and thickness not to cause a large dark current to flow at the time of reverse bias application. The above-described diffusion stop layer 18 is shown as a relatively thin region adjacent to the electron barrier layer 13 even in the band diagram. The slope of each part in the band diagram corresponds to an electric field strength applied to that part (layer). If the slope of the band is steep, a strong electric field is applied, and if the slope of the band is gentle, a weak electric field is applied.

### RELATED ART LITERATURE

### Patent Literature

Patent Literature 1: Japanese Patent No. 6458143

### Non-Patent Literature

Non-Patent Literature 1: Y. Ogiso et al., “80-GHz Bandwidth AND 1.5-V Vπ InP-Based IQ Modulator”, January 2020, IEEE Journal of Lightwave Technology, Vol. 38, No. 2, pp. 249-255

Non-Patent Literature 2: N. Kikuchi et al., “80-Gb/s Low-Driving-Voltage InP DQPSK Modulator With an n-p-i-n Structure”, June 2009, IEEE Photonics Technology Letters, Vol. 21, No. 12, pp. 787-789

### SUMMARY

### Problem to be Solved by the Invention

In the semiconductor optical modulation element with the n-i-p-n structure according to the related art described with reference to FIGS. 1A and 1B, wavelength dependency occurs in the performance of the optical modulator due to light absorption in the diffusion stop layer. Due to the influence of a loss caused by the Franz-Keldysh effect, in addition to the wavelength dependency of the reverse bias voltage, large wavelength dependency occurs in the quality of modulated light output from the MZM. More specifically, the absorption spectrum spreads to the long wavelength side, and a light insertion loss in the optical modulator is increased. The output level variation of modulated light on the long wavelength side adversely affects the SN ratio of the modulated light, degrading performance of the optical modulator.

The present invention has been made in consideration of the above-described problem and has as its object to reduce wavelength dependency in the modulation output performance of an n-i-p-n-type optical modulation element.

### Means of Solution to the Problem

According to a first aspect of the present invention, there is provided a Mach-Zehnder semiconductor optical modulation element comprising an input optical waveguide, two interference optical waveguides branched from the input optical waveguide, in which a refractive index of a core is modulated by an electrical signal, and an output optical waveguide for multiplexed modulated light from the two interference optical waveguides, wherein in each of the interference optical waveguides, on a substrate surface equivalent to a (100) plane of a semi-insulating InP semiconductor crystal substrate, a first n-type clad layer, a p-type electron barrier layer, a first buffer layer, a multi quantum well layer constituting the core, a second buffer layer, and a second n-type clad layer are arranged in an order named from the InP semiconductor crystal substrate to an upper layer, and the first buffer layer contains only As as a V group element.

Preferably, the second buffer layer can contain P and As as V group elements. A dopant of the p-type electron barrier layer can be carbon. Furthermore, a constituent material between the p-type electron barrier layer and the multi quantum well layer can be formed by a single composition, and the composition can be the same composition as a p-type electron barrier layer of the multi quantum well layer.

### Effect of the Invention

As described above, it is possible to reduce wavelength dependency of the performance of the optical modulation element.

### BRIEF DESCRIPTION OF THE DRAWINGS

FIGS. 1A and 1B show the layer structure and the band diagram of an n-i-p-n-type optical modulator according to a related art;

FIG. 2 is a graph showing the electric field strength dependency of the absorption spectrum of an InGaAsP layer;

FIGS. 3A and 3B show the layer structure and the band diagram of an n-i-p-n-type optical modulator according to the present disclosure;

FIG. 4 is a view showing the upper surface configuration of a semiconductor optical modulation element of Example 1 according to the present disclosure;

FIG. 5 is a view showing the sectional structure of a refractive index modulation region of the semiconductor optical modulation element according to Example 1; and

FIG. 6 is a view showing the sectional structure of an input optical waveguide of the semiconductor optical modulation element according to Example 1.

### DETAILED DESCRIPTION OF ILLUSTRATIVE EMBODIMENTS

An InP optical modulator having an n-i-p-n-type heterostructure is disclosed. Large wavelength dependency that occurs in the performance of an optical modulator in a semiconductor optical modulation element with an n-i-p-n structure according to a related art will be confirmed below. Then, the configuration and operation of the optical modulation element according to the present disclosure will be described.

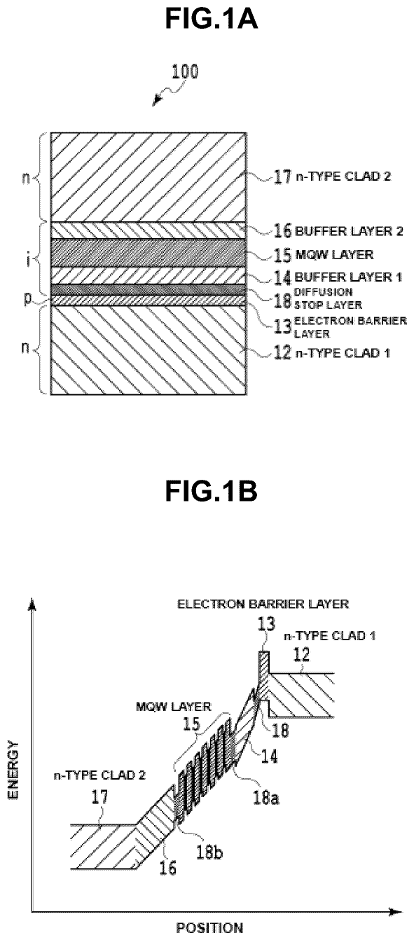

InGaAsP that is the material of a diffusion stop layer 18 shown in FIGS. 1A, 1B is known to cause optical absorption due to broadening of an absorption spectrum derived from the Franz-Keldysh effect when applying a high bias electric field for a communication wavelength in a band of 1.3 to 1.5 um. When producing a low-loss optical modulation waveguide in an MZM, the diffusion stop layer 18 formed in an undoped layer that is an electric field application region causes wavelength dependency of the quality of a modulated light output, as will be described below.

In an MZM using InP, ON/OFF modulation (intensity modulation) is executed for output light by a refractive index change mainly using the quantum-confined Stark effect by an MQW structure. As a result of the refractive index change, ON/OFF modulation is executed for output light from the MZM by phase modulation that occurs for light propagating through each of branched interference optical waveguides.

On a short wavelength side close to the band edge wavelength of the material of the optical waveguide, a desired modulation operation can be implemented with a relatively low reverse bias voltage. At 1,527 nm on the short wavelength side of the C band wavelength, a relatively low reverse bias voltage suffices with respect to a predetermined half wavelength voltage. At 1,565 nm on the long wavelength side apart from the band edge wavelength, a higher reverse bias voltage is needed. Here, the half wavelength voltage indicates the AC amplitude of an electric signal necessary for shifting the relative phase between the branched interference optical waveguides in the MZM by a half wavelength. The half wavelength voltage corresponds to the amplitude of an electric signal necessary for turning on/off the light output from the MZM. If the half wavelength voltage can be made constant independently of the wavelength, it is possible to make a modulation signal amplitude to be supplied from a DSP or the like to the MZM constant and thus simplify the system.

In the quantum-confined Stark effect, generally, dissociation of excitons associated with electric field application is impeded. For this reason, the band edge absorption spectrum does not cause broadening and exhibits a behavior of shifting to the long wavelength side. This indicates that the optical absorption amount for obtaining a desired refractive index change (phase change) does not largely change between different wavelengths. Hence, to implement a modulation operation by a constant half wavelength voltage in the whole range of the C band wavelength, only the reverse bias voltage is adjusted in accordance with the operating wavelength. However, in the n-i-p-n structure, if an InGaAsP layer or the like is formed in the undoped layer, the wavelength dependency of light absorption is large.

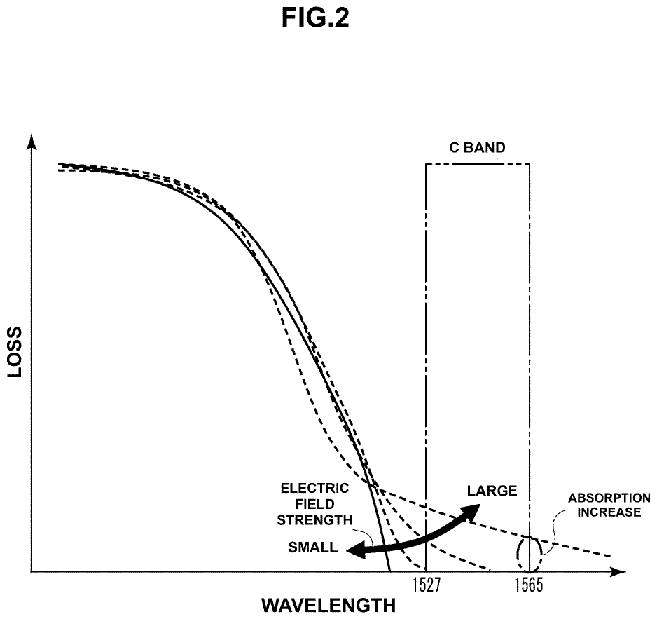

FIG. 2 is a graph for explaining the electric field strength dependency of the absorption spectrum of the InGaAsP layer. In FIG. 2, the abscissa indicates the wavelength, and the ordinate indicates the light absorption spectrum specific to the material of the InGaAsP layer, that is, a loss. If the electric field strength applied to InGaAsP is small, the absorption spectrum is on the short wavelength side apart from the C band. If the electric field strength becomes large, the absorption spectrum spreads to the C band side, and the tail of the absorption spectrum reaches the long wavelength side. Such a change of the absorption spectrum depending on the electric field strength is caused by the Franz-Keldysh effect.

The above-described wavelength dependency of the reverse bias voltage adversely affects the performance of the optical modulator (MZM) when the influence of a loss caused by the Franz-Keldysh effect is added. More specifically, when the half wavelength voltage is 2.0 V, a reverse bias voltage of about −5 V suffices at 1,527 nm on the short wavelength side of the C band wavelength. On the other hand, at 1,565 nm on the long wavelength side apart from the band edge wavelength, the modulation operation cannot be obtained with the same half wavelength voltage of 2.0 V unless a higher bias voltage of about −10 V is applied. At this time, in the n-i-p-n structure shown in FIGS. 1A, 1B, a large electric field is applied to the diffusion stop layer 18 adjacent to an electron barrier layer 13.

Referring back to FIG. 1B, changing the reverse bias voltage depending on the wavelength corresponds to changing the height difference between two n-type clad layers 12 and 17 in the band diagram. Also, to implement an operation with a constant modulation efficiency, a half wavelength voltage needs to be substantially applied to the MQW layer. As shown in FIG. 1B, the slope of the band is steep in the undoped layer between the first n-type clad layer 12 and an MQW layer 15, and a stronger electric field is applied to a buffer layer 14 and the diffusion stop layer 18. If the reverse bias voltage increases on the long wavelength side, a stronger electric field is applied to the diffusion stop layer 18 as well.

However, in exchange of increasing the reverse bias voltage, the InGaAsP absorption spectrum spreads to the long wavelength side due to the Franz-Keldysh effect, as shown in FIG. 2, and a loss occurs in light propagating through an interference optical waveguide. The intensity itself of light used for an interference operation decreases, resulting in an increase of the light insertion loss of the optical modulator. The output level variation of modulated light on the long wavelength side adversely affects the SN ratio of the modulated light as well and degrades the performance of the optical modulator. Such performance degradation is conspicuous on the long wavelength side where the influence of the Franz-Keldysh effect caused by the diffusion stop layer 18 of InGaAsP is large, and strong wavelength dependency occurs in the quality of modulated light output.

In the undoped layer, in addition to the diffusion stop layer 18 shown in FIG. 1A, an intermediate layer for switching between InP and an Al-based material (including only As as a V group element) can also exist between the MQW layer 15 containing an Al element and the electron barrier layer 13. Although not illustrated in the layer configuration shown in FIG. 1A, intermediate layers are arranged between the MQW layer 15 and the first buffer layer 14 and between the MQW layer 15 and the second buffer layer 16 and, for example, an InGaAsP layer or the like is formed. In the band diagram of FIG. 1B, these intermediate layers are shown as intermediate layers 18a and 18b.

The wavelength dependency of light absorption held by InGaAsP in the diffusion stop layer 18 and the above-described intermediate layers 18a and 18b for material switching causes large wavelength dependency in the quality of the modulated light output from the MZM.

The optical modulation element according to the present disclosure has a structure in which InGaAsP layers are eliminated as much as possible in an undoped layer (i-type layer). A first buffer layer between a p-type electron barrier layer adjacent to a first clad layer and an MQW layer has a structure in which a composition containing a material such as InGaAsP that causes optical absorption is eliminated. On the other hand, a second buffer layer between the MQW layer and a second clad layer can contain InP or InGaAsP as a material in consideration of usefulness of chemical etching selectivity at the time of device processing. That is, the first buffer layer between the p-type electron barrier layer and the MQW layer contains only As as a V group element. The second buffer layer between the MQW layer and the second clad layer may contain P and As as V group elements. By employing the structure in which InGaAsP layers are eliminated as much as possible in the undoped buffer layer, light absorption that occurs on the long wavelength side due to the Franz-Keldysh effect is suppressed, and wavelength dependency in the quality of the modulated light output of the optical modulation element is improved.

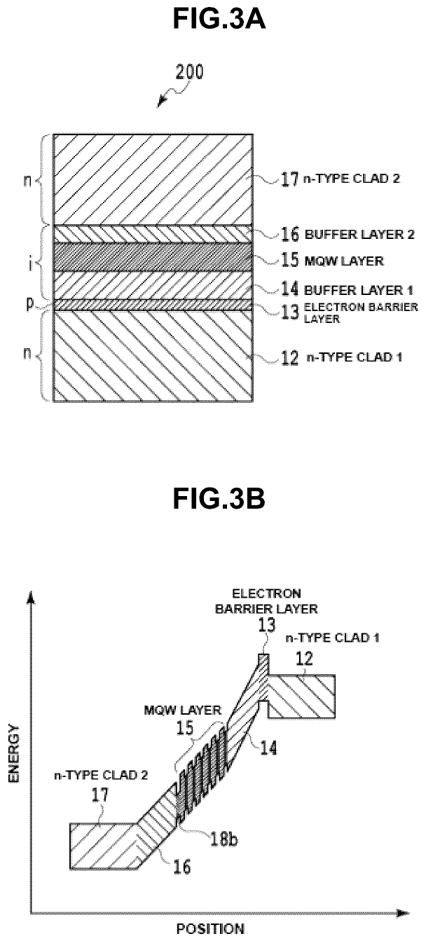

FIGS. 3A and 3B show the layer structure and the band diagram of an n-i-p-n-type semiconductor optical modulation element according to the present disclosure. FIG. 3A shows a layer structure 200 of a cross section of an optical waveguide that performs a modulation operation in an MZM. Focusing on the configuration of a semiconductor layer with an n-i-p-n structure, a part thereof is cut out and schematically shown. FIG. 3B shows a band diagram corresponding to the n-i-p-n structure shown in FIG. 3A. The basic configuration is the same as that of the optical modulation element of the related art shown in FIGS. 1A and 1B, and only different points will be described in detail.

As compared to the layer configuration of the related art shown in FIG. 1A, in the layer structure 200 of the optical waveguide of the optical modulation element according to the present disclosure, only a first buffer layer 14 is provided between a p-type electron barrier layer 13 and an MQW layer 15. The diffusion stop layer 18 shown in FIG. 1A is eliminated, and in the band diagram of FIG. 3B, only the first buffer layer 14 is included in the steep slop portion between the p-type electron barrier layer 13 and the MQW layer 15.

Another difference is a dopant in the p-type electron barrier layer 13. In the optical modulation element according to the related art, Zn is used as the p-type dopant in the electron barrier layer. In the p-type electron barrier layer 13 shown in FIG. 3A, carbon (C) is employed as the p-type dopant. This obviates the necessity of a diffusion stop layer such as an InGaAsP layer for suppressing Zn diffusion to the first buffer layer 14. As described with reference to the band diagram of the related art shown in FIG. 1B, the slope of the band between the p-type electron barrier layer 13 and the MQW layer 15 is steep, and when a strong electric field is applied, light absorption occurs on the long wavelength side due to the Franz-Keldysh effect. In the layer configuration shown in FIG. 3A, the InGaAsP layer that causes light absorption does not exist, and neither light absorption by the Franz-Keldysh effect nor the wavelength dependency of the quality of a modulated light output occurs.

In the layer configuration shown in FIG. 3A, only the single first buffer layer 14 is provided between the p-type electron barrier layer 13 and the MQW layer 15. A plurality of layers of different compositions may be included between the p-type electron barrier layer 13 and the MQW layer 15. A configuration including a plurality of layers having different compositions is also possible due to the performance of the optical modulator or a reason associated with manufacturing processes as long as only As is contained as the V group element of the buffer layer existing between the p-type electron barrier layer and the MQW layer.

To avoid carrier trap near the heterointerface, the layers from the MQW layer 15 to the p-type electron barrier layer 13 are preferably formed by a single composition. For example, these can be made of InAlAs that has a large bandgap and hardly cause optical absorption. Furthermore, InGaAlAs can also be used, although the bandgap is smaller than InAlAs.

Each of interference optical waveguides in the semiconductor optical modulation element according to the present invention has the layer structure 200 formed on a substrate surface equivalent to the (100) plane of a semi-insulating InP semiconductor crystal substrate, as will be described later. A first n-type clad layer 12, the p-type electron barrier layer 13, the first buffer layer 14, the MQW layer 15 that forms a core, a second buffer layer 16, and a second n-type clad layer 17 are arranged in this order sequentially from the substrate to the upper layer, and the first buffer layer contains only As as a V group element.

### Example 1

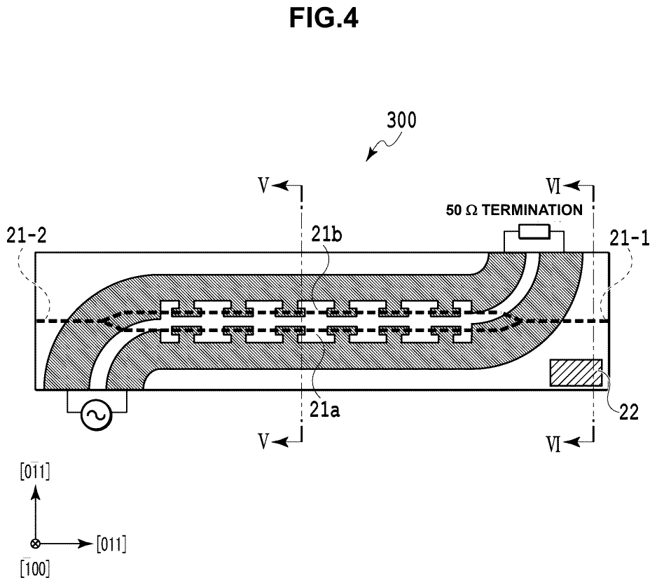

FIG. 4 is a view showing the upper surface configuration of a semiconductor optical modulation element of Example 1. An optical modulation element 300 includes an interference optical waveguide having the layer configuration shown in FIG. 3A on a semi-insulating InP (100) substrate. An input optical waveguide 21-1, two interference optical waveguides 21a and 21b branched from the input optical waveguide 21-1, and an output optical waveguide 21-2 are formed. A capacitive load type traveling-wave electrode that applies a high-frequency electrical signal is formed above the interference optical waveguides 21a and 21b, although details will not be described here. Furthermore, a DC bias electrode 22 that applies a bias voltage to a p-n junction formed by the layer configuration is formed. The optical modulation element 300 operates as an MZ optical modulator. A secondary optical effect is caused in the core layer by applying an electrical signal to the interference optical waveguides 21a and 21b, thereby modulating the refractive index of the core layer. A region including the interference optical waveguides 21a and 21b in the optical modulation element 300 is also called a refractive index modulation region.

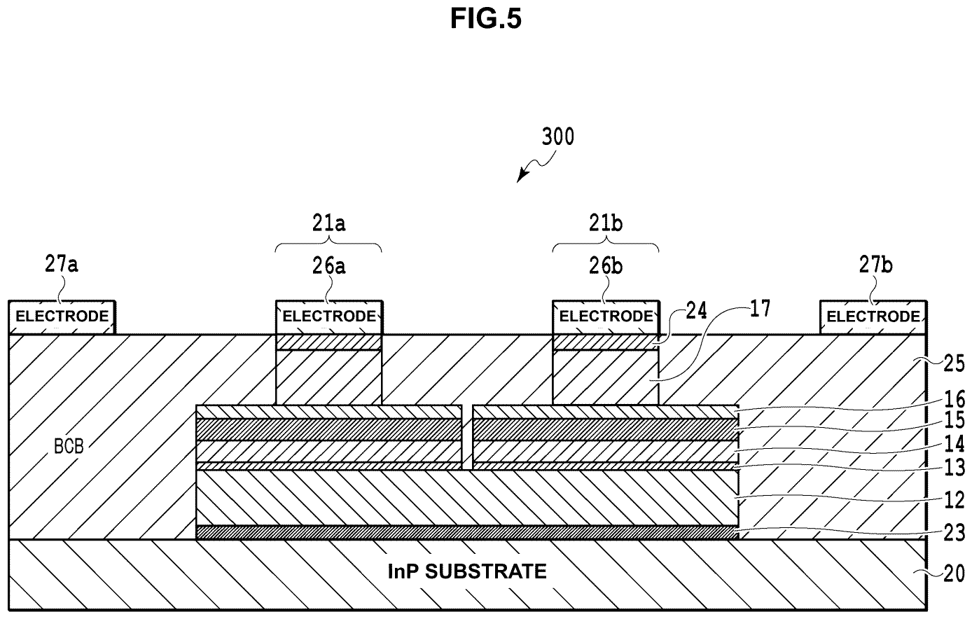

FIG. 5 is a view showing the sectional structure of the refractive index modulation region of the semiconductor optical modulation element according to Example 1. The sectional view of FIG. 5 shows a cross section taken along a line V-V in FIG. 4, which is perpendicular to the light propagation direction of the two interference optical waveguides 21a and 21b. On the semi-insulating InP substrate 20, the interference optical waveguides 21a and 21b having the n-i-p-n-type layer configuration shown in FIG. 3A are formed.

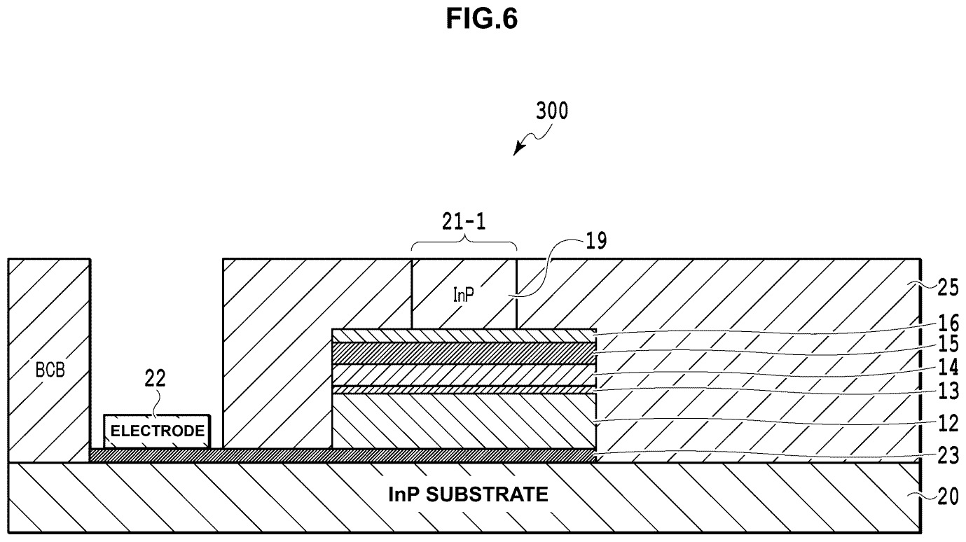

FIG. 6 is a view showing the sectional structure of the input optical waveguide of the semiconductor optical modulation element according to Example 1. The sectional view of FIG. 6 shows a cross section taken along a line VI-VI in FIG. 4, which is perpendicular to the light propagation direction of the input optical waveguide 21-1. On the InP substrate 20, the input optical waveguide 21-1 having a structure obtained by partially changing the n-i-p-n-type layer configuration shown in FIG. 3A is formed. That is, in the n-i-p-n-type layer configuration shown in FIG. 3A, a second n-type clad layer 17 is replaced with semi-insulating InP or undoped InP from the viewpoint of optical loss reduction. In addition, the DC bias electrode 22 is formed on an n-type contact layer 23 in contact with a first n-type clad layer 12. The sectional configuration of the output optical waveguide 21-2 is the same as the input optical waveguide 21-1 shown in FIG. 6. Note that FIGS. 5 and 6 are schematic views in which the structure is significantly enlarged in the thickness direction and the relationship between the thicknesses of the layers is not correctly illustrated.

A detailed configuration and the outline of the producing procedure of the optical modulation element 300 according to Example 1 will be described below. Referring back to FIG. 5, the optical modulation element 300 has the n-i-p-n-type layer configuration shown in FIG. 3A on the n-type contact layer 23 formed on the InP substrate 20. The first n-type clad layer 12, the p-type electron barrier layer 13, the first buffer layer 14, the MQW layer 15 that forms a core, the second buffer layer 16, and the second n-type clad layer 17 are arranged in this order from the InP substrate 20 to the upper layer.

As an example, the n-type contact layer 23 was made of InGaAs having a carrier concentration of 5×10¹⁸/cm³, and the first n-type clad layer 12 and the second n-type clad layer 17 were made of InP having a carrier concentration of 1×10¹⁸/cm³. Also, in consideration of a light absorption coefficient and an electrical resistivity, the carrier concentration of the p-type electron barrier layer 13 was set to 5×10¹⁷ to 1×10¹⁸/cm³, and InAlAs was employed. InAlAs has a bandgap larger than that of InP, exhibits p-type by a carbon dopant, and can thus increase the electron carrier block effect.

Each of the above-described layers was sequentially crystal-grown and deposited on a semi-insulating InP (100) substrate by organic metal vapor phase growth (MOVPE). The bandgap wavelength of the MQW layer 15 that is the core layer is decided in such a range that the electrooptic effect is caused to effectively and efficiently act at an operating light wavelength and light absorption poses no problem. For example, in the 1.55-μm band, the light emission wavelength of the MQW layer 15 was set to about 1.4 μm. In the viewpoint of high efficiency modulation, the MQW layer 15 is preferably formed by a MQW structure of InGaAlAs/InAlAs. For example, it may have a multilayer structure like InGaAlAs/InGaAlAs.

The compositions of the n-type contact layer 23 and the clad layers are not limited to those described above and, for example, an InGaAsP composition can be used without any problem. In addition, to minimize the influence of optical absorption by the p-type electron barrier layer 13 on the lower layer side, the thickness of the first n-type clad layer 12 was set to 120 nm or more in consideration of overlap to the optical mode confined in the MQW layer.

After the above-described n-i-p-n-type semiconductor layer was deposited, the second n-type clad layer 17 above the region that does not contribute to modulation is removed by dry etching and wet etching to electrically isolate elements. In the input optical waveguide 21-1 and the output optical waveguide 21-2, the portion where the second n-type clad layer 17 was removed was backfilled by semi-insulating InP or undoped InP 19 from the viewpoint of optical loss reduction.

After the layer structure of the semiconductor was produced, an MZ interferometer optical waveguide made of SiO formed in a direction equivalent to the [011] plane direction was formed, and a ridge-shaped optical waveguide shown in FIG. 5 was formed using dry etching and wet etching processes. Next, dry/wet etching was further executed to form a bias voltage electrode on the first n-type clad layer 12 on the lower layer side, thereby exposing a part of the n-type contact layer 23, as shown in FIG. 6.

After that, as an insulating film, benzocyclobutene (BCB) 25 was applied to flatten unevenness of the optical waveguide. After the BCB in the contact region was removed, a capacitive load type traveling-wave electrode pattern as shown in FIG. 4 was formed by gold plating. As the insulating film, not the BCB but polyimide that is an insulating low refractive index material may be used.

To drive the produced semiconductor optical modulation element as an optical modulator, a predetermined bias was applied to the DC bias electrode 22 such that a reverse direction electric field was applied to the p-n junction, and a high-frequency signal was supplied to a signal electrode (coplanar strip line). As a result, the optical modulator could be driven by supplying a single-phase signal. Even if the optical modulator was driven by supplying a differential signal from the viewpoint of low power consumption, there was no problem.

As described above in detail, according to the present invention, it is possible to reduce wavelength dependency in the modulation output performance of an n-i-p-n-type optical modulation element.

### Industrial Applicability

The present invention can generally be used for optical communication.

1.-6. (canceled)

7. A Mach-Zehnder semiconductor optical modulator comprising:
an input optical waveguide;
two interference optical waveguides branched from the input optical waveguide, in which a refractive index of a core is modulated by an electrical signal; and
an output optical waveguide for multiplexed modulated light from the two interference optical waveguides,
wherein in each of the interference optical waveguides,
a first n-type clad layer,
a p-type electron barrier layer,
a first buffer layer,
a multi quantum well layer constituting the core,
a second buffer layer, and
a second n-type clad layer, are arranged, on a substrate surface equivalent to a (100) plane of a semi-insulating InP semiconductor crystal substrate, in an order named from the InP semiconductor crystal substrate to an upper layer, and
the first buffer layer contains only As as a V group element.

8. The semiconductor optical modulator according to claim 7, wherein the second buffer layer contains P and As as V group elements.

9. The semiconductor optical modulator according to claim 7, wherein a dopant of the p-type electron barrier layer is carbon.

10. The semiconductor optical modulator according to claim 7, wherein a constituent material between the p-type electron barrier layer and the multi quantum well layer is composed of a single composition, and the composition is the same as that of the p-type electron barrier layer or the multi quantum well layer.

11. The semiconductor optical modulator according to claim 7, wherein the multi quantum well layer contains an Al element, and the first buffer layer, the multi quantum well layer, and the second buffer layer are undoped layers.

12. The semiconductor optical modulator according to claim 7, wherein each of the two interference optical waveguides has a ridge structure.

13. The semiconductor optical modulator according to claim 8, wherein a dopant of the p-type electron barrier layer is carbon.

14. The semiconductor optical modulator according to claim 8, wherein a constituent material between the p-type electron barrier layer and the multi quantum well layer is composed of a single composition, and the composition is the same as that of the p-type electron barrier layer or the multi quantum well layer.

15. The semiconductor optical modulator according to claim 8, wherein the multi quantum well layer contains an Al element, and the first buffer layer, the multi quantum well layer, and the second buffer layer are undoped layers.

16. The semiconductor optical modulator according to claim 8, wherein each of the two interference optical waveguides has a ridge structure.

17. A Mach-Zehnder semiconductor optical modulator comprising:
an input optical waveguide;
two interference optical waveguides branched from the input optical waveguide; and
an output optical waveguide for multiplexed modulated light from the two interference optical waveguides,
wherein each of the interference optical waveguides comprises:
a first n-type clad layer;
a p-type electron barrier layer doped with carbon as a p-type dopant;
an undoped layer comprising a multi quantum well layer that forms a core, the undoped layer being free of an InGaAsP diffusion stop layer between the p-type electron barrier layer and the multi quantum well layer; and
a second n-type clad layer,
wherein the undoped layer contains only As as a V group element in a region between the p-type electron barrier layer and the multi quantum well layer.

18. The semiconductor optical modulator according to claim 17, wherein the undoped layer comprises a first buffer layer between the p-type electron barrier layer and the multi quantum well layer, and a second buffer layer between the multi quantum well layer and the second n-type clad layer.

19. The semiconductor optical modulator according to claim 17, wherein the multi quantum well layer comprises InGaAlAs/InAlAs or InGaAlAs/InGaAlAs.

20. The semiconductor optical modulator according to claim 17, wherein the first n-type clad layer has a thickness of 120 nm or more.

21. A method of manufacturing a Mach-Zehnder semiconductor optical modulator, comprising:
sequentially depositing, on a substrate surface equivalent to a (100) plane of a semi-insulating InP semiconductor crystal substrate by organic metal vapor phase growth:
a first n-type clad layer;
a p-type electron barrier layer doped with carbon;
a first buffer layer containing only As as a V group element;
a multi quantum well layer;
a second buffer layer; and
a second n-type clad layer;
forming an input optical waveguide, two interference optical waveguides branched from the input optical waveguide, and an output optical waveguide for multiplexed modulated light from the two interference optical waveguides; and
forming a capacitive load type traveling-wave electrode above the two interference optical waveguides.

22. The method according to claim 21, wherein the p-type electron barrier layer comprises InAlAs.

23. The method according to claim 21, further comprising:
removing the second n-type clad layer above a region that does not contribute to modulation by dry etching and wet etching; and
backfilling the removed portion with semi-insulating InP or undoped InP.

24. The method according to claim 21, further comprising:
forming a ridge-shaped optical waveguide using dry etching and wet etching processes;
applying an insulating film to flatten unevenness of the optical waveguide; and
forming the capacitive load type traveling-wave electrode pattern by gold plating.
